(19) United States
(12) Patent Application Publication
(10) Pub. No.: US 2004/0205458 A1
(43) Pub. Date: Oct. 14, 2004

(54) Efficient real-time networked documents conversion for distance meeting environments

(76) Inventors: Jenq-Neng Hwang, Bellevue, WA (US); Tony Chan, Issaquah, WA (US)

Correspondence Address: Jenq-Neng Hwang, Suite A101, 18005 N.E. 68th St., Redmond, WA, 98052, US

(21) Appl. No.: 10/004,310

(22) Filed: Nov. 23, 2001

(51) Int. Cl. G06F 17/24

(52) U.S. Cl. 715/500; 715/526

(57) ABSTRACT

As millions of computers sold every year into the consumer and corporate market and over hundreds of millions of PCs connected to the Internet, whose users and exchanged data grew by orders of magnitude in last 5 years. Even though traditional telephone and mobile phone will still provide effective point-to-point audio-only communications, it will be PCs (desktops and laptops) and handheld devices in the near future that provide real-time multipoint multimedia communication over the emerging IP network. In addition to the exchange of audio/video and textchat data from distance sites, more and more services allow joint viewing and annotating of documents, which bear different kinds of formats varying from PowerPoint, Word, Excel, Postscript, Text, and various image formats (bitmap, gif, and jpeg). This calls for a new development effort by HomeMeeting to design and implement a new unified document converter for real-time meeting/conferencing applications.

### REFERENCES

[1] Tristan Richardson, Quentin Stafford-Fraser, Kenneth R. Wood & Andy Hopper, “Virtual Network Computing”, IEEE Internet Computing, Vol.2 No.1, January/February, pp33-38, 1998.

[2] L. J. Locher, “Troubleshooting with NetMeeting—More than just an audio and video conferencing tool,” Windows 2000 magazine, pp. 81-85, March 2000.

[3] Jeannette M. Wing and John Ockerbloom, “Respectful Type Converters,” IEEE Transactions on Software Engineering, Vol. 26, No. 7, pp. 579-593, July 2000.

### TECHNICAL FIELD

This invention relates to a software document converter for unified real-time networked conversion of popular office documents into presentable image formats.

### BACKGROUND OF THE INVENTION

As millions of computers sold every year into the consumer and corporate market and over hundreds of millions of PCs connected to the Internet, whose users and exchanged data grew by orders of magnitude in last 5 years. Even though traditional telephone and mobile phone will still provide effective point-to-point audio-only communications, it will be PCs (desktops and laptops) and handheld devices in the near future that provide real-time multipoint multimedia communication over the emerging IP network. In addition to the exchange of audio/video and textchat data from distance sites, more and more services allow joint viewing and annotating of documents, which bear different kinds of formats varying from PowerPoint, Word, Excel, Postscript, Text, and various image formats (bitmap, gif, and jpeg).

HomeMeeting Inc. provides complete Internet service (www.homemeeting.com) for multipoint multimedia IP-communication network. To the best of our knowledge, this is the first attempt of fully Internet-based interactive multipoint multimedia WAN communication service with enhanced quality of service (QoS) and a complete suite of presentation/discussion functionalities over narrowband (as low as 26.4 Kbps) connections. Every registered member of this service can sign into the Member Meeting Center from HomeMeeting's website, schedule meeting, invite meeting participants, and pre-upload documents for online discussion. To make efficient the real-time networked documents conversion for distance meeting environments, the inventors thus proposed this unified document conversion technique which converts most popular document formats (e.g., PowerPoint, Word, Excel, Postscript) into either JPEG or GIF image formats, whichever has a smaller data size after conversion. Both formats allow joint viewing by Internet browsers and can be jointly marked/annotated for discussion purpose.

### Prior Art

To implement these joint viewing and annotating of documents, many software adopt the concept of either share desktop or share application approaches. The share desktop approach, which dumps the screen of the coordinator to all the meeting participants. Virtual Network Computing (VNC) [Richardson, 1998], http://www.uk.research.att.com/vnc/index.html, is such a remote display system which allows you to view a computing ‘desktop’ environment not only on the machine where it is running, but from anywhere on the Internet and from a wide variety of machine architectures. The shared desktop approach can be very effective if the participating users are in the same local area network (LAN), otherwise the bandwidth demand is pretty high, which makes it difficult to operate over wide area networks where routers are ineffective in routing large size or very irregular size data packets. On the other hand, shared application approach, which requires all users running the same application software (e.g., Microsoft PowerPoint), and the command inputs from one computer is also broadcast to and executed in the rest of participants' computers. One such example is the Microsoft NetMeeting software, http://www.microsoft.com/windows/netmeeting/, [Poor, 2000]. The shared application approach requires less bandwidth consumption, while calls for a consistent version of the same application software, and increased CPU and memory requirement, etc.

To overcome the difficulties encountered in the above techniques, this invention proposed a unified document conversion technique which converts most popular document formats (e.g., PowerPoint, Word, Excel, Postscript) into either JPEG or GIF image formats, whichever has a smaller data size after conversion. Both formats allow joint viewing by Internet browsers and can be jointly marked/annotated for discussion purpose.

Similar efforts have been made by http://tom.cs.cmu.edu/intro.html, where offline conversion of diverse document formats based on a special data model, entitled Typed Object Model (or TOM), was developed [Wing and Okerbloom, 1998]. TOM is a read-only object-oriented data model that describes the abstract structure of data formats, their concrete representations, and relations between formats. TOM is supported by a distributed network of mediator agents (known as type brokers) that maintain information about data formats, and provide uniform access to conversions and other operations on those formats. With its target on converting all kinds of documents to any other formats, it is commonly very time consuming without the guarantee of accuracy. Furthermore, the efficiency of TOM is low when applied to real-time document conversion into image formats for joint browsing and joint marking/annotation.

### Objects and Advantages

This invention proposed a unified real-time networked software document converter which effectively receives an outside agent document conversion task request, arranges appropriate Engines to complete conversions, and calls different conversion engines and execute them efficiently. This converter can simultaneously support different types of communication interface to handle multiple documents for the same meeting or for different meetings. In addition, this system can determine conversion requirements, arranges appropriate Engines to complete conversions, and replies conversion status to requesters. Moreover, the system can maintain a waiting list of conversion requests in case all Engines are busy, the newly arriving jobs are placed in the waiting list to be dispatched based on the assigned priority, as well as keep track the conversion status of each job to allow some jobs going through several stages of conversion.

### SUMMARY OF THE INVENTION

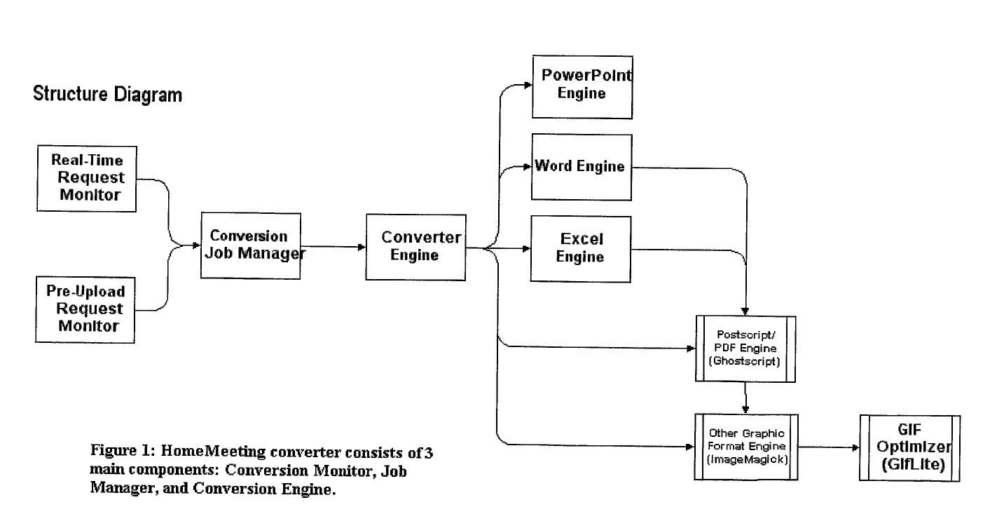

HomeMeeting Converter is a unified document converter designed to convert files from one format to another format. It consists of 3 main components: Conversion Monitor (“Monitor”), Job Manager (“Manager”), and Conversion Engine (“Engine”). The three-tier structure is designed to increase performance, flexibility and scalability. Converter can be configured to run multiple instances of Monitors, Managers, and Engines (see FIG. 1).

[image]

### DETAILED DESCRIPTION OF THE INVENTION

Conversion Monitor: A Conversion Monitor is the interface to communicate outsider agents who request file conversion. Its job is passing conversion request to Job Manager and notifying conversion requester when the request is completed. Communication method can be event driven (for real-time conversion) or polling (for pre-upload conversion). To increase effectiveness, Converter can run multiple Monitors to simultaneously support different types of communication interface. For example, one Monitor can continuously listen to a network port and receives on-demand requests while another Monitor can periodically read a database for new requests.

Job Manager: A Job Manager is the middleman between Monitor and Engine. It accepts conversion requests, determines conversion requirements, arranges appropriated Engines to complete conversions, and replies conversion status to requesters. In other words, it is the personal assistant for the Engine, and it manages the entire conversion process.

A waiting list of conversion requests is maintained within the Manager. When a conversion request Bob) is received from Monitor, Manager attempts to send the job to the appropriated Engines. If all Engines are busy, the job is placed to waiting list. A job is dispatched as soon as the next Engine becomes available. Manager intelligently selects next job by considering a job's priority and its deadline. In most cases, a job with higher priority will be dispatched first. However, if there is a job with lower priority but has a close deadline, it may be dispatched first instead. In addition of job dispatching, Job Manager is also responsible to keep track the conversion status of each job. Some jobs require going through several stages of conversion; thus they are sent to Engines multiple times. For example, a conversion from Word document to graphic format requires three conversion phases: 1) from Word format to Postscript format; 2) from Postscript to Bitmap; and 3) from Bitmap to GIF/JPG.

When an Engine finishes a job, it notifies the Manager, and Manager examines the job. If a job is completely finished or cannot be completed, Manager informs Monitor which in turns notifies the job's requester. If a job is partial completed, it is put back to the waiting list and waits for next available Engine. However, to increase performance, Manager may decide to inform Monitor if a portion of the job is completed in a way such that the completed portion is in ready-to-use form. For example, when an Engine has just finished converting 2 pages of a 10-page Word document, Manager notify the requester, so it can begin process/retrieve the completed portion of the converted file.

Conversion Engine: Conversion engine is the central part of converter. It receives job from monitor, completes the job, and reply the status to Monitor. To increase flexibility, Conversion Engine is modularized into many small engines, and each engine is dedicated to convert specific type of file, for example, one engine converts Word files, another engine converts Postscript files, and a third engine converts Bitmap files. To support additional file formats, we can simply add new modules and configure Manager to send jobs appropriately. Currently, HomeMeeting Converter has the following types of Engines.

Word to Postscript converter (using Microsoft Word and Postscript printer driver);

Excel to Postscript converter (using Microsoft Excel and Postscript printer driver);

PowerPoint to GIF/JPG converter (using Microsoft PowerPoint);

Postscript/PDF to Bitmap converter (using Aladdin Ghostscript);

Bitmap/Text/PCX/PICT to GIF/JPG converter (using ImageMagick); and

GIF file compressor (using GifLite)

In order to successfully implement these engines, we adopted several of public domain softwares:

Microsoft Office: http://office.microsoft.com/

AFPL Ghostscript: http://www.ghostscript.com/

ImageMagick: http://www.imagemagick.org/

GIFLite: http://www.chinaccm.com/08/b08/b0801/tuxing/b1-04.asp

PSSelect: http://www.dcs.ed.ac.uk/home/ajcd/psutils/

### II. Time Management and Scalability of the Converter

Moreover, time management is introduced into Engines to increase efficiency. For instance, an Engine may receive a big job that requires 10 minutes to finish. Instead of engaging an Engine solely to complete this job for such a long period of time, an Engine may choose to complete a portion of the job and report the job status to Monitor. Then, Monitor can decide whether the Engine should continue to do the job or should do another job with higher priority.

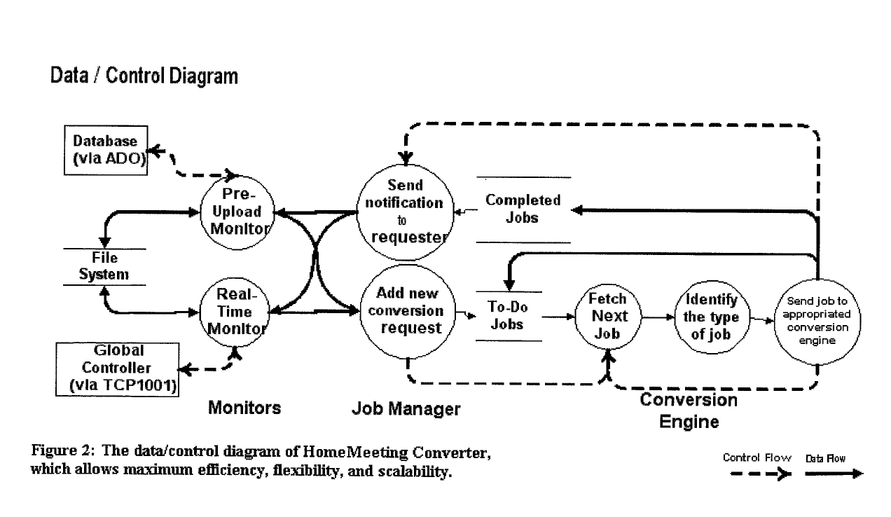

In addition to efficiency and flexibility, HomeMeeting Converter is also scalable. As indicated in the Data/Control diagram in FIG. 2, this Converter can be configured to run on multiple computers, instead of running on a single computer. Engines can run on different computers to reduce CPU load and memory usage, which improves system performance. Job requests can be sent to the Engine that is closer to the requester to improve network usage and reduce file transfer time. The speed of file transfer can be a performance hit when files are transferred over a long distance congested network, for example, across Pacific Ocean.

[image]

What is claimed is:

1. A unified real-time networked software document converter comprising:
a) means (conversion monitors) to receive an outside agent document conversion task request;
b) means (a job manager) to arrange appropriate conversion Engines to complete conversions;
c) means (engine integration) to call different conversion engines and execute them efficiently;

2. The system of claim 1 further comprises multiple Conversion Monitors to simultaneously support different types of communication interface. This support can be for the multiple documents for the same meeting or for different meetings.

3. The system of claim 1 further comprises a management module that determines conversion requirements, arranges appropriate Engines to complete conversions, and replies conversion status to requesters.

4. The system of claim 1 further comprises a pool of many modularized small engines, with each engine being dedicated to convert specific type of file format.

5. The system of claim 2 also allows the Communication method to be either event driven (for real-time conversion) or polling (for pre-upload conversion).

6. The system of claim 3 further comprises a maintained waiting list of conversion requests in case all Engines are busy, the newly arriving jobs are placed in the waiting list to be dispatched based on the assigned priority.

7. The system of claim 3 further comprises a maintained waiting list of conversion requests in case all Engines are busy, the newly arriving jobs are placed in the waiting list to be dispatched based on the assigned priority or the deadline urgency.

8. The system of claim 3 further comprises a process to keep track the conversion status of each job to allow some jobs going through several stages of conversion.
